(19) United States
(12) Patent Application Publication
(10) Pub. No.: US 2023/0419147 A1
(43) Pub. Date: Dec. 28, 2023

(54) ION CHAIN MOTIONAL MODE MEASUREMENT BY FAST SCAN WITH MAXIMUM WEIGHT MATCHING METHOD

(71) Applicant: IONQ, INC., College Park, MD (US)

(72) Inventors: Ming LI, Silver Spring, MD (US); Omar SHEHAB, Hyattsville, MD (US); Yunseong NAM, North Bethesda, MD (US)

(21) Appl. No.: 17/982,879

(22) Filed: Nov. 8, 2022

Related U.S. Application Data
(60) Provisional application No. 63/281,308, filed on Nov. 19, 2021.

(51) Int. Cl. G06N 10/40; G06F 15/82

(52) U.S. Cl. CPC G06N 10/40; G06F 15/82

(57) ABSTRACT

A method of performing a computational process using a quantum computer includes measuring a coupling strength of each trapped ion in an ion chain and each motional mode of the ion chain, wherein the trapped ions comprises first trapped ions that are addressable by laser beams, and second trapped ions that are not addressable by laser beams, computing a first map of the first trapped ions to the motional modes, wherein the motional mode comprises first motional modes that are allocated by the first map and second motional modes that are unallocated by the first map, measuring frequencies of the first motional modes, computing a second map of the first trapped ions to the second motional modes, measuring frequencies of the second motional modes, and outputting the measured frequencies of the motional modes, to be used for computing a pulse to be applied to the ion chain.

### CROSS-REFERENCE TO RELATED APPLICATIONS

This application claims the benefit to U.S. Provisional Application No. 63/281,308, filed Nov. 19, 2021, which is incorporated by reference herein.

### BACKGROUND

### Field

The present disclosure generally relates to a method and a system for performing trapped-ion based quantum computations with high fidelity, and more specifically, to a method and a system for performing optimal fast scan measurements of motional mode frequencies of an ion chain by optimally mapping of trapped ions in the ion chain to motional modes by a maximum weight matching method and measuring motional sideband transition of the trapped ions individually in parallel.

### Description of the Related Art

In trapped ion based quantum computers, quantum information is encoded in the atomic states of trapped ions (interchangeably referred to as “qubits” hereinafter) in an ion chain, where the motional modes, originated from the collective motion of the trapped ions in the ion chain, act as a quantum information bus for entangling gate operations between trapped ions, such as two-qubit Mølmer-Sørensen gate operations. Fidelity of the entangling gate operations depends greatly upon the accurate knowledge of the motional mode frequencies of the ion chain. The motional mode frequencies vary with time due to varying stray fields in an ion trap. Therefore, the motional mode frequencies need to be continually monitored, to maximize fidelity of a quantum computational process, by performing motional sideband spectroscopy measurements on trapped ions in the ion chain. The number of motional mode frequencies that need to be monitored is equal to the number of trapped ions in the ion chain. Thus, the number of laser pulses required for the motional sideband spectroscopy measurements, or equivalently the measurement time, scales linearly with the number of motional mode frequencies, and various heating mechanisms may become more significant in a longer ion chain with a large number of trapped ions. This may eventually limit accurate measurements of the motional mode frequencies and affect the fidelity of a computation performed by a quantum computer.

Thus, there is a need for a procedure to efficiently measure motional mode frequencies.

### SUMMARY

Embodiments of the present disclosure provide a method of performing a computational process using a quantum computer. The method includes measuring, by a system controller, a coupling strength of each of a plurality of trapped ions in an ion chain and each of a plurality of motional modes of the ion chain, wherein the plurality of trapped ions comprises a plurality of first trapped ions that are addressable by laser beams controlled by the system controller, and a plurality of second trapped ions that are not addressable by laser beams controlled by the system controller, computing, by a classical computer, a first map of the plurality of first trapped ions to the plurality of motional modes, wherein the plurality of motional mode comprises a plurality of first motional modes that are allocated by the first map and a plurality of second motional modes that are unallocated by the first map, measuring, by the system controller, frequencies of the plurality of first motional modes, by measuring motional sideband transitions in the plurality of first trapped ions, computing, by the classical computer, a second map of the plurality of first trapped ions to the plurality of second motional modes, measuring, by the system controller, frequencies of the plurality of second motional modes, by measuring motional sideband transitions in the first trapped ions that are mapped to the plurality of second motional modes, and outputting, by the classical computer, the measured frequencies of the plurality of motional modes, to be used for computing a pulse to be applied to the ion chain for performing an entangling gate operation between a pair of trapped ions in the ion chain.

Embodiments of the present disclosure also provide an ion trap quantum computing system. The ion trap quantum computing system includes a quantum processor comprising a plurality of trapped ions in an ion chain, each trapped ion having two hyperfine states, a system controller configured to execute a control program to control one or more laser beams to perform operations on the quantum processor, and non-volatile memory having a number of instructions stored therein. The number of instructions, when executed by one or more processors, causes the ion trap quantum computing system to perform operations including measuring, by the system controller, a coupling strength of each of the plurality of trapped ions in the ion chain and each of a plurality of motional modes of the ion chain, wherein the plurality of trapped ions comprises a plurality of first trapped ions that are addressable by the one or more laser beams, and a plurality of second trapped ions that are not addressable by the one or more laser beams, computing, by the classical computer, a first map of the plurality of first trapped ions to the plurality of motional modes, wherein the plurality of motional mode comprises a plurality of first motional modes that are allocated by the first map and a plurality of second motional modes that are unallocated by the first map, measuring, by the system controller, frequencies of the plurality of first motional modes, by measuring motional sideband transitions in the plurality of first trapped ions, computing, by the classical computer, a second map of the plurality of first trapped ions to the plurality of second motional modes, measuring, by the system controller, frequencies of the plurality of second motional modes, by measuring motional sideband transitions in the first trapped ions that are mapped to the plurality of second motional modes, and outputting, by the classical computer, the measured frequencies of the plurality of motional modes, to be used for computing a pulse to be applied to the ion chain for performing an entangling gate operation between a pair of trapped ions in the ion chain.

Embodiments of the present disclosure further provide a quantum computing system. The quantum computing system includes a plurality of trapped ions in an ion chain, each of the trapped ions having two hyperfine states defining a qubit, one or more lasers configured to emit a laser beam, which is provided to the ion chain, a system controller configured to control the one or more lasers to perform first operations on the ion chain, and a classical computer configured to perform second operations. The first operations include measuring a coupling strength of each of a plurality of trapped ions in an ion chain and each of a plurality of motional modes of the ion chain, wherein the plurality of trapped ions comprises a plurality of first trapped ions that are addressable by laser beams, and a plurality of second trapped ions that are not addressable by laser beams. The second operations include computing a first map of the plurality of first trapped ions to the plurality of motional modes, wherein the plurality of motional mode comprises a plurality of first motional modes that are allocated by the first map and a plurality of second motional modes that are unallocated by the first map. The first operations further include measuring frequencies of the plurality of first motional modes, by measuring motional sideband transitions in the plurality of first trapped ions. The second operations further include computing a second map of the plurality of first trapped ions to the plurality of second motional modes. The first operations further include measuring frequencies of the plurality of second motional modes, by measuring motional sideband transitions in the first trapped ions that are mapped to the plurality of second motional modes. The second operations further include outputting, by the classical computer, the measured frequencies of the plurality of motional modes, to be used for computing a pulse to be applied to the ion chain for performing an entangling gate operation between a pair of trapped ions in the ion chain.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a partial view of an ion trap quantum computer according to one embodiment.

FIG. 2 depicts a schematic view of an ion trap for confining ions in a chain according to one embodiment.

FIGS. 3A, 3B, and 3C depict a few schematic collective transverse motional mode structures of a chain of five trapped ions.

FIG. 4 depicts a schematic energy diagram of each ion in a chain of trapped ions according to one embodiment.

FIGS. 5A and 5B depict schematic views of the motional sideband spectrum of each ion and a motional mode according to one embodiment.

FIG. 6 depicts a flowchart illustrating a method 600 of optimal fast scan measurements of motional mode frequencies according to one embodiment.

To facilitate understanding, identical reference numerals have been used, where possible, to designate identical elements that are common to the figures. In the figures and the following description, an orthogonal coordinate system including an X-axis, a Y-axis, and a Z-axis is used. The directions represented by the arrows in the drawing are assumed to be positive directions for convenience. It is contemplated that elements disclosed in some embodiments may be beneficially utilized on other implementations without specific recitation.

### DETAILED DESCRIPTION

Embodiments described herein are generally related to a method of efficiently determining the actual frequencies of motional modes of an ion chain that may be different from frequencies of the motional modes calculated based on a particular configuration of trapped ions in the ion chain, and thus use the determined actual frequencies to improve the accuracy of a quantum computer's computational process results. In some embodiments, the method includes performing fast scan measurements of motional mode frequencies by optimally mapping trapped ions to measure motional modes by a maximum weight matching method and measuring motional sideband transitions of mapped trapped ions individually in parallel.

It should be noted that although the method is described herein for measurements of motional mode frequencies, this optimal mapping method can also be applied to motional sideband cooling of the motional modes of the ion.

### General Hardware Configurations

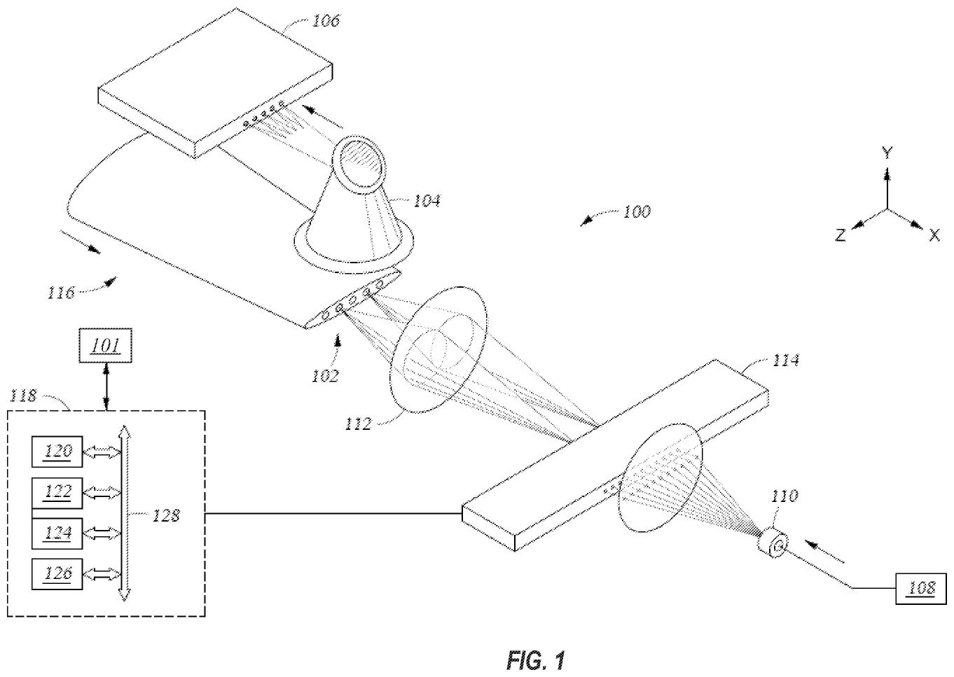

FIG. 1 is a partial view of an ion trap quantum computer, or system 100, according to one embodiment. The system 100 includes a classical (digital) computer 101, a quantum register that is a chain 102 of trapped ions (i.e., five shown) that extend along the Z-axis, and a system controller 118.

The classical computer 101 includes a central processing unit (CPU), memory, and support circuits (or I/O). The memory is connected to the CPU, and may be one or more of a readily available memory, such as a read-only memory (ROM), a random-access memory (RAM), floppy disk, hard disk, or any other form of digital storage, local or remote. Software instructions, algorithms and data can be coded and stored within the memory for instructing the CPU. The support circuits (not shown) are also connected to the CPU for supporting the processor in a conventional manner. The support circuits may include conventional cache, power supplies, clock circuits, input/output circuitry, subsystems, and the like. The classical computer 101 performs supporting and system control tasks including selecting a quantum algorithm to be run by use of a user interface, such as graphics processing unit (GPU), compiling the selected quantum algorithm into a series of universal quantum logic gate operations, translating the series of universal quantum logic gate operations into laser pulses to apply on the quantum register, and pre-calculating parameters related to the laser pulses (such as an amplitude function and a detuning function of a laser pulse) to perform gate operations, by use of software programs stored in memory and a central processing unit (CPU).

The quantum register includes trapped ions in the ion chain 102. Each trapped ion in the ion chain 102 is an ion having a nuclear spin I and an electron spin S such that a difference between the nuclear spin I and the electron spin S is zero, such as a positive ytterbium ion, ¹⁷¹Yb⁺, a positive barium ion ¹³³Ba⁺, a positive cadmium ion ¹¹¹Cd⁺ or ¹¹³Cd⁺, which all have a nuclear spin

$$I = \frac{1}{2}$$

and the ²S_{1/2} hyperfine states. In some embodiments, all trapped ions in the ion chain 102 are the same species and isotope (e.g., ¹⁷¹Yb⁺). In some other embodiments, the ion chain 102 includes one or more species or isotopes (e.g., some ions are ¹⁷¹Yb⁺ and some other ions are ¹³³Ba⁺). In yet additional embodiments, the ion chain 102 may include various isotopes of the same species (e.g., different isotopes of Yb, different isotopes of Ba). The trapped ions in the ion chain 102 are coupled with various hardware and individually addressed with separate laser beams.

An imaging objective 104, such as an objective lens with a numerical aperture (NA), for example, of 0.37, collects fluorescence along the Y-axis from the trapped ions and maps each ion onto a multi-channel photo-multiplier tube (PMT) 106 for measurement of individual trapped ions. Non-copropagating Raman laser beams from a laser 108, which are provided along the X-axis, perform operations on the trapped ions. A diffractive beam splitter 110 creates an array of static Raman laser beams 112 that are individually switched using a multi-channel acousto-optic modulator (AOM) 114 and is configured to selectively act on individual trapped ions. A global Raman laser beam 116 illuminates all trapped ions at once. In some embodiments, individual Raman laser beams (not shown) each illuminate individual trapped ions. The system controller (also referred to as a “RF controller”) 118 receives from the pre-calculated parameters for laser pulses at the beginning of performing gate operations on the quantum register, controls various hardware (e.g., lasers, the AOM 114) associated with controlling any and all aspects used to run the selected algorithm on the quantum register, and returns a read-out of the quantum register and thus output of results of the quantum computation(s) at the end of performing the gate operations to the classical computer 101. The system controller 118 includes a central processing unit (CPU) 120, a read-only memory (ROM) 122, a random-access memory (RAM) 124, a storage unit 126, and the like. The CPU 120 is a processor of the system controller 118. The ROM 122 stores various programs and the RAM 124 is the working memory for various programs and data. The storage unit 126 includes a nonvolatile memory, such as a hard disk drive (HDD) or a flash memory, and stores various programs even if power is turned off. The CPU 120, the ROM 122, the RAM 124, and the storage unit 126 are interconnected via a bus 128. The system controller 118 executes a control program which is stored in the ROM 122 or the storage unit 126 and uses the RAM 124 as a working area. The control program will include one or more software applications that include program code (e.g., instructions) that may be executed by a processor in order to perform various functionalities associated with receiving and analyzing data and controlling any and all aspects of the methods and hardware used to create the ion trap quantum computer system 100 discussed herein.

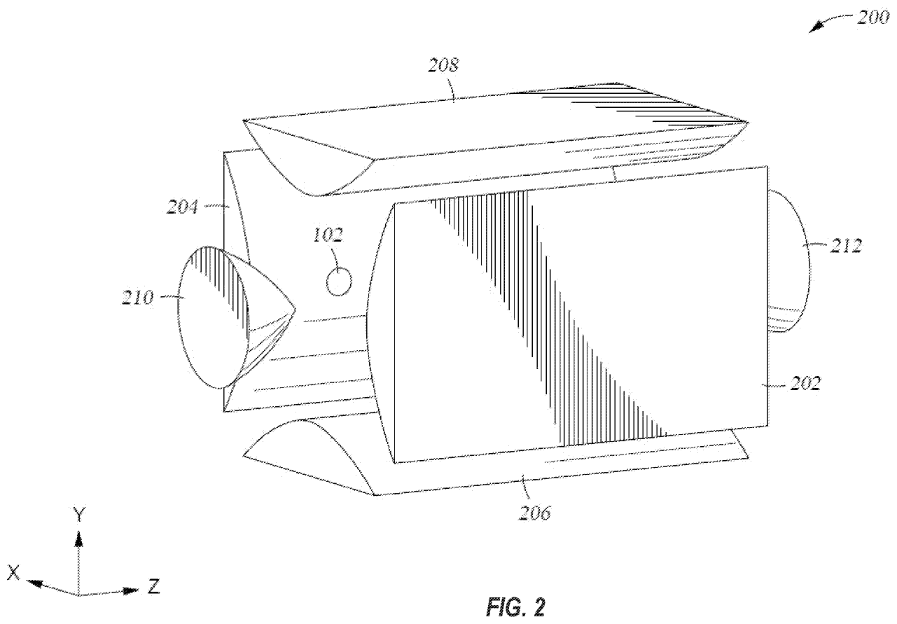

FIG. 2 depicts a schematic view of an ion trap 200 (also referred to as a Paul trap) for confining ions in the ion chain 102 according to one embodiment. The confining potential is exerted by both static (DC) voltage and radio frequency (RF) voltages. A static (DC) voltage V s is applied to end-cap electrodes 210 and 212 to confine the ions along the Z-axis (also referred to as an “axial direction,” “longitudinal direction,” or “first direction”). The ions in the ion chain 102 are nearly evenly distributed in the axial direction due to the Coulomb interaction between the ions. In some embodiments, the ion trap 200 includes four hyperbolically-shaped electrodes 202, 204, 206, and 208 extending along the Z-axis.

During operation, a sinusoidal voltage V₁ (with an amplitude V_{RF}/2) is applied to the opposing pair of electrodes 202, 204 and a sinusoidal voltage V 2 with a phase shift of 180° from the sinusoidal voltage V₁ (and the amplitude V_{RF}/2) is applied to the other opposing pair of electrodes 206, 208 at a driving frequency ω_{RF}, generating a quadrupole potential. In some embodiments, a sinusoidal voltage is only applied to one opposing pair of electrodes (e.g., 202, 204), and the other opposing pair of electrodes (206, 208) are grounded. The quadrupole potential creates an effective confining force in the X-Y plane perpendicular to the Z-axis (also referred to as a “radial direction,” “transverse direction,” or “second direction”) for each of the trapped ions, which is proportional to the distance from a saddle point (i.e., a position in the axial direction (Z-direction)) at which the RF electric field vanishes. The motion in the radial direction (i.e., direction in the X-Y plane) of each trapped ion is approximated as a harmonic oscillation (referred to as secular motion) with a restoring force towards the saddle point in the radial direction and can be modeled by spring constants kₓ and k_{y}, respectively. In some embodiments, the spring constants in the radial direction are modeled as equal when the quadrupole potential is symmetric in the radial direction. However, undesirably in some cases, the motion of the trapped ions in the radial direction may be distorted due to some asymmetry in the physical trap configuration, a small DC patch potential due to inhomogeneity of a surface of the electrodes, or the like and due to these and other external sources of distortion the trapped ions may lie off-center from the saddle points.

It should be noted that the particular configuration described above is just one among several possible examples of a trap for confining ions according to the present disclosure and does not limit the possible configurations, specifications, or the like of traps according to the present disclosure. For example, the geometry of the electrodes is not limited to the hyperbolic electrodes described above. In other examples, a trap that generates an effective electric field causing the motion of the trapped ions in the radial direction as harmonic oscillations may be a multi-layer trap in which several electrode layers are stacked and an RF voltage is applied to two diagonally opposite electrodes, or a surface trap in which all electrodes are located in a single plane on a chip. Furthermore, a trap may be divided into multiple segments, adjacent pairs of which may be linked by shuttling one or more ions, or coupled by photon interconnects. A trap may also be an array of individual trapping regions arranged closely to each other on a micro-fabricated ion trap chip. In some embodiments, the quadrupole potential has a spatially varying DC component in addition to the RF component described above.

### Trapped Ion Configuration and Quantum Bit Information

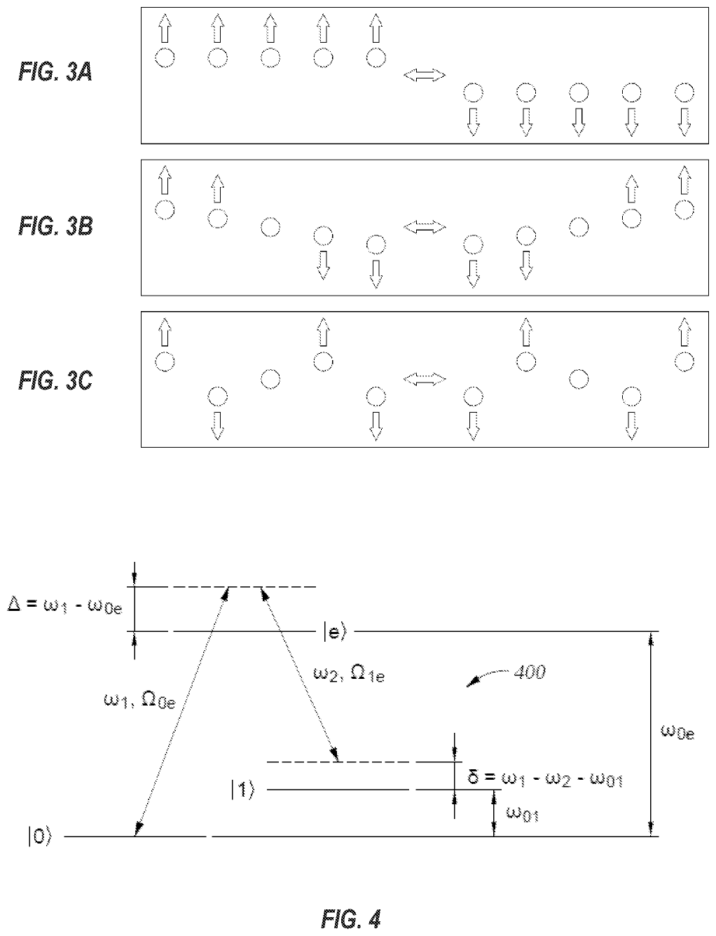

FIGS. 3A, 3B, and 3C depict a few schematic structures of collective transverse motional modes (also referred to simply as “motional mode structures”) of a chain 102 of five trapped ions, for example. Here, the confining potential due to a static voltage V s applied to the end-cap electrodes 210 and 212 is weaker compared to the confining potential in the radial direction. The collective motional modes of the ion chain 102 in the transverse direction are determined by the Coulomb interaction between the trapped ions combined with the confining potentials generated by the ion trap 200. The trapped ions undergo collective transversal motions (referred to as “collective transverse motional modes,” “collective motional modes,” or simply “motional modes”), where each mode has a distinct energy (or equivalently, a frequency) associated with it. A motional mode having the p-th lowest energy is hereinafter referred to as |nₚₕ [symbol] ₚ, where nₚₕ denotes the number of motional quanta (in units of energy excitation, referred to as phonons) in the motional mode, and the number of motional modes P in a given transverse direction is equal to the number of trapped ions N in the ion chain 102. FIGS. 3A-3C schematically illustrate examples of different types of collective transverse motional modes that may be experienced by five trapped ions that are positioned in a chain 102. FIG. 3A is a schematic view of a common motional mode |nₚₕ [symbol] ₚ having the highest energy. In the common motional mode |nₚₕ [symbol] ₚ, all trapped ions oscillate in phase in the transverse direction. FIG. 3B is a schematic view of a tilt motional mode |nₚₕ [symbol] _{P-1} which has the second highest energy. In the tilt motional mode, trapped ions on opposite ends move out of phase in the transverse direction (i.e., in opposite directions). FIG. 3C is a schematic view of a higher-order motional mode |nₚₕ [symbol] _{P-3} which has a lower energy than that of the tilt motional mode |nₚₕ [symbol] _{P-1}, and in which the trapped ions move in a more complicated mode pattern.

FIG. 4 depicts a schematic energy diagram 400 of each trapped ion in the ion chain 102 according to one embodiment. Each trapped ion in the ion chain 102 is an ion having a nuclear spin I and an electron spin S such that a difference between the nuclear spin I and the electron spin S is zero. In one example, each ion may be a positive ytterbium ion, ¹⁷¹Yb⁺, which has a nuclear spin

$$I = \frac{1}{2}$$

and the ²S_{1/2} hyperfine states (i.e., two electronic states) with an energy split corresponding to a frequency difference (referred to as a “carrier frequency”) of ω₀₁/2π=12.642812 GHz. In other examples, each ion may be a positive barium ion ¹³³Ba⁺, a positive cadmium ion ¹¹¹Cd⁺ or ¹¹³Cd⁺, which all have a nuclear spin

$$I = \frac{1}{2}$$

and the ²S_{1/2} hyperfine states. A qubit is formed with the two hyperfine states, denoted as |0 [symbol] and ∥1 [symbol] , where the hyperfine ground state (i.e., the lower energy state of the ²S_{1/2} hyperfine states) is chosen to represent |0 [symbol] . Hereinafter, the terms “hyperfine states,” “internal hyperfine states,” and “qubits” may be interchangeably used to represent |0 [symbol] and |1 [symbol] . Each ion may be cooled (i.e., kinetic energy of the ion may be reduced) to near the motional ground state |0 [symbol] ₚ for any motional mode p with no phonon excitation (i.e., nₚₕ=0) by known laser cooling methods, such as Doppler cooling or resolved sideband cooling, and then the qubit state prepared in the hyperfine ground state |0 [symbol] by optical pumping. Here, |0 [symbol] represents the individual qubit state of a trapped ion whereas |0 [symbol] ₚ with the subscript p denotes the motional ground state for a motional mode p of the ion chain 102.

An individual qubit state of each trapped ion may be manipulated by, for example, a mode-locked laser at 355 nanometers (nm) via the excited ²P_{1/2} level (denoted as |e [symbol] ). As shown in FIG. 4, a laser beam from the laser may be split into a pair of non-copropagating laser beams (a first laser beam with frequency ω₁ and a second laser beam with frequency ω₂) in the Raman configuration, and detuned by a one-photon transition detuning frequency Δ=ω₁−ω₀ₑ with respect to the transition frequency ω₀ₑ between |0 [symbol] and |e [symbol] , as illustrated in FIG. 4. A two-photon transition detuning frequency δ includes adjusting the amount of energy that is provided to the trapped ion by the first and second laser beams, which when combined is used to cause the trapped ion to transfer between the hyperfine states |0 [symbol] and |1 [symbol] . When the one-photon transition detuning frequency Δ is much larger than the two-photon transition detuning frequency (also referred to simply as “detuning frequency”) δ=ω₁−ω₂−ω₀₁ (hereinafter denoted as ±μ, μ being a positive value), single-photon Rabi frequencies Ω₀ₑ(t) and Ω₁ₑ(t) (which are time-dependent, and are determined by amplitudes and phases of the first and second laser beams), at which Rabi flopping between states |0 [symbol] and |e [symbol] and between states |1 [symbol] and |e [symbol] respectively occur, and a spontaneous emission rate from the excited state |e [symbol] , Rabi flopping between the two hyperfine states |0 [symbol] and |1 [symbol] (referred to as a “carrier transition”) is induced at the two-photon Rabi frequency Ω(t). The two-photon Rabi frequency Ω(t) has an intensity (i.e., absolute value of amplitude) that is proportional to Ω₀ₑΩ₁ₑ/2Δ, where Ω₀ₑ and Ω₁ₑ are the single-photon Rabi frequencies due to the first and second laser beams, respectively. Hereinafter, this set of non-copropagating laser beams in the Raman configuration to manipulate internal hyperfine states of qubits (qubit states) may be referred to as a “composite pulse” or simply as a “pulse,” and the resulting time-dependent pattern of the two-photon Rabi frequency Ω(t) may be referred to as an “amplitude” of a pulse or simply as a “pulse,” which are illustrated and further described below. The detuning frequency δ=ω₁−ω₂−ω₀₁ may be referred to as detuning frequency of the composite pulse or detuning frequency of the pulse. The amplitude of the two-photon Rabi frequency Ω(t), which is determined by amplitudes of the first and second laser beams, may be referred to as an “amplitude” of the composite pulse.

It should be noted that the particular atomic species used in the discussion provided herein is just one example of atomic species which have stable and well-defined two-level energy structures when ionized and an excited state that is optically accessible, and thus is not intended to limit the possible configurations, specifications, or the like of an ion trap quantum computer according to the present disclosure. For example, other ion species include alkaline earth metal ions (Be⁺, Ca⁺, Sr⁺, Mg⁺, and Ba⁺) or transition metal ions (Zn⁺, Hg⁺, Cd⁺).

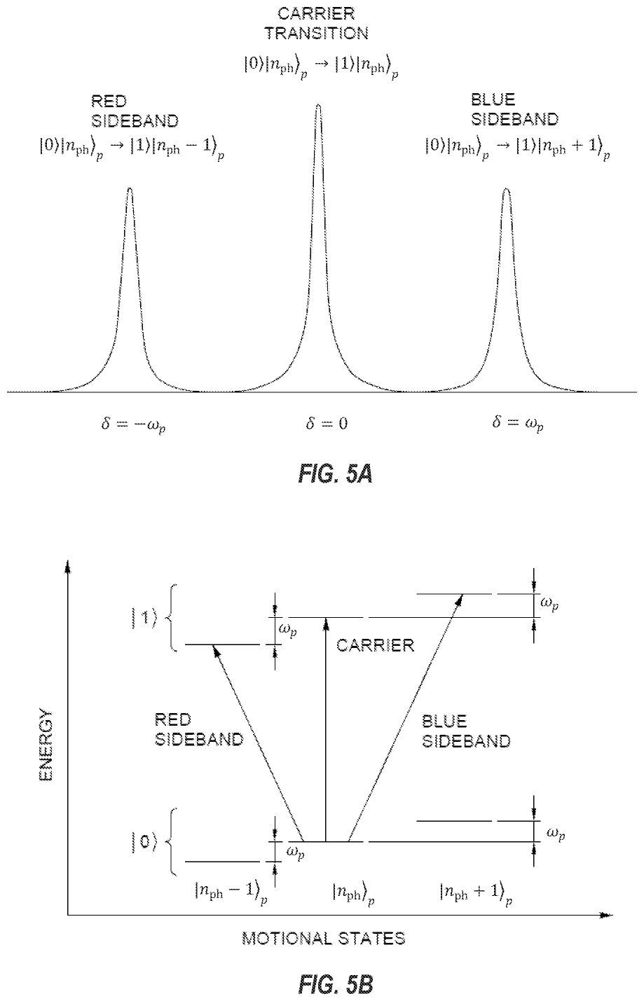

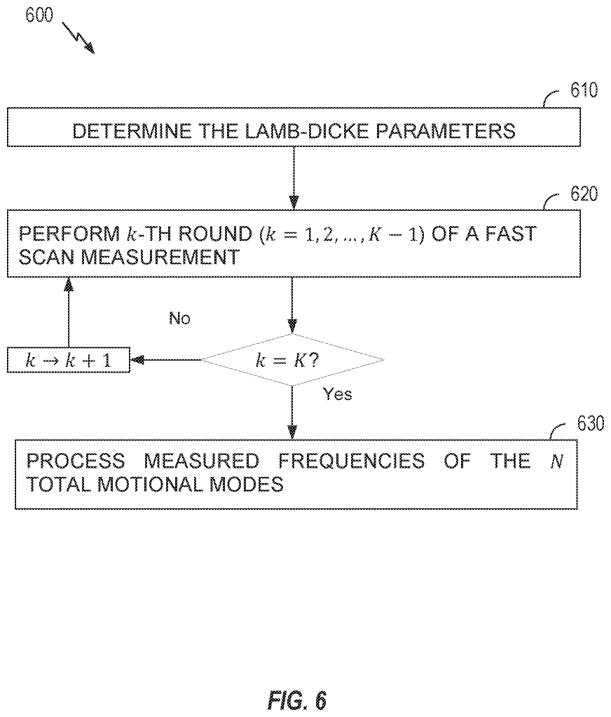

In an ion trap quantum computer, the motional modes may act as a data bus to mediate entanglement between two qubits and this entanglement is used to perform an entangling gate operation. That is, each of the two qubits is entangled with the motional modes, and then the entanglement is transferred to an entanglement between the two qubits by using motional sideband excitations, as described below. FIGS. 5A and 5B schematically depict views of a motional sideband spectrum for a trapped ion in the ion chain 102 in a motional mode |nₚₕ [symbol] ₚ having frequency ωₚ according to one embodiment. As illustrated in FIG. 5B, when the detuning frequency of the composite pulse is zero (i.e., the frequency difference between the first and second laser beams is tuned to the carrier frequency, δ=ω₁−ω₂−ω₀₁=0), simple Rabi flopping between the qubit states |0 [symbol] and |1 [symbol] (carrier transition) occurs. When the detuning frequency of the composite pulse is positive (i.e., the frequency difference between the first and second laser beams is tuned higher than the carrier frequency, δ=ω₁−ω₂−ω₀₁=μ>0, referred to as a blue sideband), Rabi flopping between combined qubit-motional states |0 [symbol] nₚₕ [symbol] ₚ and |1 [symbol] nₚₕ+1 [symbol] ₚ occurs (i.e., a transition from the p-th motional mode with nₚₕ-phonon excitations denoted by |nₚₕ [symbol] ₚ to the p-th motional mode with (nₚₕ+1)-phonon excitations denoted by |nₚₕ+1 [symbol] ₚ occurs when the qubit state |0 [symbol] flips to |1 [symbol] ). When the detuning frequency of the composite pulse is negative (i.e., the frequency difference between the first and second laser beams is tuned lower than the carrier frequency by the frequency ωₚ of the motional mode |nₚₕ [symbol] ₚ, δ=ω₁−δ₂−ω₀₁=−μ<0, referred to as a red sideband), Rabi flopping between combined qubit-motional states |0 [symbol] |nₚₕ [symbol] ₚ and |1 [symbol] |nₚₕ−1 [symbol] ₚ occurs (i.e., a transition from the motional mode |nₚₕ [symbol] ₚ to the motional mode |nₚₕ−1 [symbol] ₚ with one less phonon excitations occurs when the qubit state |0 [symbol] flips to |1 [symbol] ). A π/2-pulse on the blue sideband applied to a qubit transforms the combined qubit-motional state |0 [symbol] |nₚₕ [symbol] ₚ into a superposition of |0 [symbol] nₚₕ [symbol] ₚ and |1 [symbol] |nₚₕ+1 [symbol] ₚ. A π/2-pulse on the red sideband applied to a qubit transforms the combined qubit-motional state |0 [symbol] |nₚₕ [symbol] ₚ into a superposition of |0 [symbol] |nₚₕ [symbol] ₚ and ═1 [symbol] |nₚₕ−1 [symbol] ₚ. When the two-photon Rabi frequency Ω(t) is smaller as compared to the detuning frequency δ=ω₁−ω₂−ω₀₁=±μ the blue sideband transition or the red sideband transition may be selectively driven. Thus, a qubit can be entangled with a desired motional mode by applying the right type of pulse, such as a π/2-pulse, which can be subsequently entangled with another qubit, leading to an entanglement between the two qubits. Entanglement between qubits is needed to perform an entangling gate operation in an ion trap quantum computer.

By controlling and/or directing transformations of the combined qubit-motional states as described above, an entangling gate operation may be performed on two qubits (i-th and j-th qubits). In general, an entangling gate operation, by the application of the composite pulse on the motional sidebands for duration τ (referred to as a “gate duration”), having an amplitude function Ω(t) and a detuning frequency function μ(t), respectively transforms two-qubit states |0 [symbol] ᵢ|0 [symbol] ⱼ, |0 [symbol] ᵢ|1 [symbol] ⱼ, |1 [symbol] ᵢ|0 [symbol] ⱼ, and |1 [symbol] ᵢ|1 [symbol] ⱼ as follows:

|0 [symbol] ᵢ|0 [symbol] ⱼ→cos(2χ_{i,j}(τ))|0 [symbol] ᵢ|0 [symbol] ⱼ−i sin(2χ_{i,j}(τ))|1 [symbol] ᵢ|1 [symbol] ⱼ

|0 [symbol] ᵢ|0 [symbol] ⱼ→cos(2χ_{i,j}(τ))|0 [symbol] ᵢ|1 [symbol] ⱼ−i sin(2χ_{i,j}(τ))|1 [symbol] ᵢ|1 [symbol] ⱼ

|1 [symbol] ᵢ|0 [symbol] ⱼ→−i sin(2χ_{i,j}(τ))|0 [symbol] ᵢ|1 [symbol] ⱼ+cos(2χ_{i,j}(τ))|1 [symbol] ᵢ|0 [symbol] ⱼ

|1 [symbol] ᵢ|1 [symbol] ⱼ→−i sin(2χ_{i,j}(τ))|0 [symbol] ᵢ|0 [symbol] ⱼ+cos(2χ_{i,j}(τ))|1 [symbol] ᵢ|0 [symbol] ⱼ

in terms of an entangling interaction χ_{i,j}(τ),

χ_{i,j}(τ)=Σₚ₌₁^{p}η_{i,p}η_{i,p}∫₀^{τ}dt∫₀^{t}dt′Ω(t)Ω(t′)sin(ψ(t))sin(ψ(t′))sin[ωₚ(t′−t)],

where η_{i,p} is the Lamb-Dicke parameter that quantifies the coupling strength between the i-th ion and the p-th motional mode having the frequency ωₚ, ψ(t) is an accumulated phase function (also referred to simply as a “phase function”) ψ(t)=ψ₀+∫₀^{t}μ(t′)dt′ of the pulse, ψ₀ is an initial phase which may be assumed to be zero (0) hereinafter for simplicity without loss of generality, and P is the number of the motional modes (equal to the number N of trapped ions in the ion chain 102).

### Measurement of Motional Mode Frequencies

The entanglement between two qubits (trapped ions) described above can be used to perform an entangling gate operation. The entangling gate operation along with single-qubit operations (R gates) can be used to build a quantum computer to perform desired computational processes. In constructing a pulse to deliver to the ion chain 102 for performing an entangling gate operation between two trapped ions (e.g., i-th and j-th trapped ions) in the ion chain 102, an amplitude function Ω(t) and a detuning frequency function μ(t) of the pulse are adjusted as control parameters to ensure the pulse performs the intended entangling gate operation, based on the knowledge of the motional mode frequencies ωₚ (p=0, 1, . . . , P−1). Thus, to perform an accurate entangling gate operation, the motional mode frequencies ωₚ need to be accurately measured prior to the execution of the entangling gate operation.

In an ion trap quantum computing system, such as the system 100, there can be discrepancies in the actual motional mode frequencies ωₚ of an ion chain from the ideal motional mode frequencies (based on the ideal longitudinal distribution of trapped ions in which the trapped ions in the ion chain are equally spaced) due to, for example, varying stray electric field along the locally varying DC quadrupole potential along the ion chain. Such discrepancies lead to degraded fidelity of the entangling gate operations if the amplitudes Ω⁽ⁱ⁾(t) and Ω^{(j)}(t) of the pulse to be applied to the i-th and the j-th trapped ions to perform the entangling gate operations are computed based on the ideal longitudinal distribution of trapped ions in the ion chain. In particular, in a long ion chain, various heating mechanisms known in the art and hardware resource overhead that cause the discrepancies may be significant, and thus lower fidelity of an entangling gate operation and time available for executing other gate operations.

Conventionally, each of the actual motional mode frequencies ωₚ is measured sequentially by motional sideband spectroscopy, in which motional sideband transitions in trapped ions are measured, to provide a motional sideband spectrum, for example, as shown in FIG. 5A, because measurement of each motional mode frequency ωₚ requires different Raman laser beam frequencies for the motional sideband transitions. The number of pulses and equivalently the time required for the measurements of the motional mode frequencies ωₚ increase as the number P (=N) of the motional modes p increases.

Alternatively, in an ion quantum computing system, such as the quantum computing system 100, where individual trapped ions can be addressed (i.e., laser beams for motional sideband spectroscopy can be focused on individual trapped ions at individually controlled laser beam frequencies), the measurement of the motional mode frequencies ωₚ can be done in parallel.

Known algorithms for the maximum weight matching method include, but are not limited to, Hungarian algorithm, Edmonds' algorithm, Witzgall-Zahn's algorithm, Balinski's algorithm, Gabow's algorithm, Lawler's algorithm, Karzanov's algorithm, Hoperoft-Karp's algorithm, Dinic-Karzanov's algorithm, Micali-Vazirani's algorithm, Gabow-Tarjan's algorithm, Ibarra-Moran's algorithm, Rabin-Vazirani's algorithm, Alt-Blum-Mehlhorn-Paul's algorithm, Feder-Motwani's algorithm, Goldberg-Kennedy's algorithm, Cheriyan-Mehlhorn's algorithm, Goldberg-Karzanov's algorithm, Mucha-Sankowski's algorithm, and Harvey's algorithm.

In the example described herein, s trapped ions among the total N trapped ions in the ion chain 102 are not addressable, since, for example, they are not well aligned with an AOM, such as the AOM 114, or Raman laser beams, and/or located near end-cap electrodes of an ion trap. Thus, frequencies of the total P motional modes (P=N) are measured using (N−s) trapped ions. In one example, 5 trapped ions (s=5) may not be addressable among 25 (N=25) total trapped ions. Since the number of addressable trapped ions (N−s) is less than the number of motional modes P (=N), the fast scan measurement is repeated over K multiple rounds, where K is the minimum integer that satisfies K·(N−s)≥N, to enhance the quality of the measurements.

The method 600 begins with block 610 in which the Lamb-Dicke parameters η_{i,p} that specifies a coupling strength of the trapped ion i and the motional mode p are determined. The Lamb-Dicke parameters η_{i,p} can be determined by measuring participation of individual trapped ions i in each motional mode p by motional sideband spectroscopy that is known in the art, using Raman laser beams, such as Raman beams 112, to excite the motional sideband transitions, and hardware, such as PMT 106, to measure fluorescence from the motional mode sideband transition, controlled by a system controller, such as the system controller 118. The motional mode spectrum of trapped ion i, for example, as shown in FIG. 5A indicates probability of carrier transition of trapped ion i (i.e., transition between the two qubit states of trapped ion i). The determined Lamb-Dicke parameters η_{i,p} are used as weights of the edges E in the weighted graph G=(V,E) when the matching of trapped ions to motional modes using the maximum weight matching method.

In block 620, a k-th round (k=1, 2, . . . , K−1) of a fast scan measurement is performed. Each round of a fast scan measurement has two steps. First, an optimal mapping of (N−s) total addressable trapped ions to (N−s) motional modes out of the N total motional modes is computed, by a classical computer, such as the classical computer 101. This mapping is computed by the maximum weight matching method, to ensure the computed mapping is optimum (e.g., a sum of the absolute values of the Lamb-Dicke parameters η_{i,p}) between each of the addressable trapped ions and the mapped motional mode. Second, the motional sideband transitions of the (N−s) total addressable trapped ions are measured individually in parallel. This measurement is performed using Raman laser beams, such as Raman beams 112, to excite the motional sideband transitions, and hardware, such as PMT 106, to measure fluorescence from the motional mode sideband transition, controlled by a system controller (e.g., system controller 118). The results of the measurement provides frequencies of the (N−s) motional modes that are allocated with the (N−s) total addressable trapped ions. The measured frequencies of the (N−s) motional modes are stored in memory of a classical computer, such as the classical computer 101. Thus, in each round of a fast scan measurement, frequencies of the (N−s) motional modes are measured and stored, and frequencies of the s motional modes that are unallocated are not measured. The frequencies of the s motional modes that are not measured are measured in a subsequent round of a fast scan. Repetition of a fast scan measurement by K rounds, where K·(N−s)≥N, is sufficient to measure frequencies of the N total motional modes. In the example where 5 trapped ions (s=5) are not addressable among 25 (N=25) total trapped ions, two rounds of a fast scan can measure frequencies of all 25 total motional modes.

For example, in the first round (k=1), the (N−s) total addressable trapped ions are mapped to N total motional modes by the maximum weight matching method using a maximum weight matching algorithm, selected from algorithms known in the art as listed above. In one example, the Hungarian algorithm method is used. This results in a mapping of the (N−s) total addressable trapped ions to (N−s) motional modes out of the N total motional modes, and leaving s motional modes that are unallocated. Based on this mapping, a fast scan measurement of the (N−s) motional modes that are allocated is performed by measuring the motional sideband transitions in the (N−s) total addressable trapped ions.

In the second round (k=2), the (N−s) total addressable trapped ions are mapped to the s motional modes that were unallocated in the first round by the maximum weight matching method. This results in a mapping of up to (N−s) addressable trapped ions to the yet-to-be allocated motional modes again up to (N−s), and the originally allocated (N−s) motional modes are unallocated.

In the k-th round (k=2, 3, . . . , K), up to (N−s) total addressable trapped ions are mapped to the motional modes that have yet to be allocated until in the (k−1)-th round by the maximum weight matching method.

This fast scan measurement is repeated K rounds.

In block 630, the frequencies of the N total motional modes are processed, by a classical computer, such as the classical computer 101. The set of the determined frequencies of the N total motional modes is outputted, by a classical computer, such as the classical computer 101, to be used to construct pulses to perform entangling gate operations between two trapped ions in the ion chain.

In the embodiments described herein, methods of efficient measurements of actual frequencies of motional modes of an ion chain that may be different from the frequencies of the motional modes calculated based on a particular configuration of trapped ions in the ion chain. In the fast scan method described herein, trapped ions in the ion chain are individually mapped to measure motional mode frequencies by the maximum weight matching method, thus with the guarantee that the mapping is optimum. The motional mode frequencies that are measured by the fast scan method can be used to construct pulses to be delivered to perform entangling gate operations in the ion chain. The processes described herein can thus be used to greatly increase the speed of the scanning processes of actual motional modes required to perform accurate computational processes performed by the quantum computer, and thus greatly reduce the overhead time it takes to perform the scanning processes performed prior to a desired computation performed by the classical and quantum computer.

It should be noted that although the method is described herein for measurements of motional mode frequencies, this optimal mapping method can also be applied to sideband cooling of the motional modes of the trapped ion.

While the foregoing is directed to specific embodiments, other and further embodiments may be devised without departing from the basic scope thereof, and the scope thereof is determined by the claims that follow.

1. A method of performing a computational process using a quantum computer, comprising:
measuring, by a system controller, a coupling strength of each of a plurality of trapped ions in an ion chain and each of a plurality of motional modes of the ion chain, wherein the plurality of trapped ions comprises a plurality of first trapped ions that are addressable by laser beams controlled by the system controller, and a plurality of second trapped ions that are not addressable by laser beams controlled by the system controller;
computing, by a classical computer, a first map of the plurality of first trapped ions to the plurality of motional modes, wherein the plurality of motional mode comprises a plurality of first motional modes that are allocated by the first map and a plurality of second motional modes that are unallocated by the first map;
measuring, by the system controller, frequencies of the plurality of first motional modes, by measuring motional sideband transitions in the plurality of first trapped ions;
computing, by the classical computer, a second map of the plurality of first trapped ions to the plurality of second motional modes;
measuring, by the system controller, frequencies of the plurality of second motional modes, by measuring motional sideband transitions in the first trapped ions that are mapped to the plurality of second motional modes; and
outputting, by the classical computer, the measured frequencies of the plurality of motional modes, to be used for computing a pulse to be applied to the ion chain for performing an entangling gate operation between a pair of trapped ions in the ion chain.

2. The method according to claim 1, wherein the first map is computed based on a maximum weight matching method.

3. The method according to claim 1, wherein the second map is computed based on a maximum weight matching method.

4. The method according to claim 1, further comprising: and
computing, by the classical computer, a third map of the first trapped ions that are not mapped to the plurality of second motional modes to the plurality of motional modes that are not allocated by the second map, wherein the plurality of motional modes that are not allocated by the second map comprises a plurality of third motional modes that are allocated by the third map and a plurality of fourth motional modes that are not allocated by the third map; and
measuring, by the system controller, frequencies of the plurality of third motional modes, by measuring motional sideband transitions in the first trapped ions that are mapped to the plurality of third motional modes.

5. The method according to claim 1, further comprising:
computing, by the classical computer, an amplitude function and a detuning frequency function of a pulse to be applied to the ion chain for performing an entangling gate operation between a pair of trapped ions in the ion chain, based on the outputted frequencies of the frequencies of the plurality of motional modes of the ion chain; and
applying, by the system controller, the pulse having the computed amplitude function and the detuning frequency function to the ion chain to perform the entangling gate operation between the pair of trapped ions in the ion chain.

6. The method according to claim 1, wherein the measuring of motional sideband transitions in the plurality of first trapped ions is performed by using laser beams that are focused on individual trapped ions at individually controlled laser beam frequencies.

7. An ion trap quantum computing system, comprising:
a classical computer;
a quantum processor comprising a plurality of trapped ions in an ion chain, each trapped ion having two hyperfine states;
a system controller configured to execute a control program to control one or more laser beams to perform operations on the quantum processor; and
non-volatile memory having a number of instructions stored therein which, when executed by one or more processors, causes the ion trap quantum computing system to perform operations comprising:
measuring, by the system controller, a coupling strength of each of the plurality of trapped ions in the ion chain and each of a plurality of motional modes of the ion chain, wherein the plurality of trapped ions comprises a plurality of first trapped ions that are addressable by the one or more laser beams, and a plurality of second trapped ions that are not addressable by the one or more laser beams;
computing, by the classical computer, a first map of the plurality of first trapped ions to the plurality of motional modes, wherein the plurality of motional mode comprises a plurality of first motional modes that are allocated by the first map and a plurality of second motional modes that are unallocated by the first map;
measuring, by the system controller, frequencies of the plurality of first motional modes, by measuring motional sideband transitions in the plurality of first trapped ions;
computing, by the classical computer, a second map of the plurality of first trapped ions to the plurality of second motional modes;
measuring, by the system controller, frequencies of the plurality of second motional modes, by measuring motional sideband transitions in the first trapped ions that are mapped to the plurality of second motional modes; and
outputting, by the classical computer, the measured frequencies of the plurality of motional modes, to be used for computing a pulse to be applied to the ion chain for performing an entangling gate operation between a pair of trapped ions in the ion chain.

8. The ion trap quantum computing system according to claim 7, wherein the first map is computed based on a maximum weight matching method.

9. The ion trap quantum computing system according to claim 7, wherein the second map is computed based on a maximum weight matching method.

10. The ion trap quantum computing system according to claim 7, further comprising: and
computing, by the classical computer, a third map of the first trapped ions that are not mapped to the plurality of second motional modes to the plurality of motional modes that are not allocated by the second map, wherein the plurality of motional modes that are not allocated by the second map comprises a plurality of third motional modes that are allocated by the third map and a plurality of fourth motional modes that are not allocated by the third map; and
measuring, by the system controller, frequencies of the plurality of third motional modes, by measuring motional sideband transitions in the first trapped ions that are mapped to the plurality of third motional modes.

11. The ion trap quantum computing system according to claim 7, wherein the operations further comprise:
computing, by the classical computer, an amplitude function and a detuning frequency function of a pulse to be applied to the ion chain for performing an entangling gate operation between a pair of trapped ions in the ion chain, based on the outputted frequencies of the frequencies of the plurality of motional modes of the ion chain; and
applying, by the system controller, the pulse having the computed amplitude function and the detuning frequency function to the ion chain to perform the entangling gate operation between the pair of trapped ions in the ion chain.

12. The ion trap quantum computing system according to claim 7 wherein the measuring of motional sideband transitions in the plurality of first trapped ions is performed by using laser beams that are focused on individual trapped ions at individually controlled laser beam frequencies.

13. A quantum computing system, comprising:
a plurality of trapped ions in an ion chain, each of the trapped ions having two hyperfine states defining a qubit;
one or more lasers configured to emit a laser beam, which is provided to the ion chain;
a system controller configured to control the one or more lasers to perform first operations on the ion chain; and
a classical computer configured to perform second operations, wherein
the first operations comprise:
measuring a coupling strength of each of a plurality of trapped ions in an ion chain and each of a plurality of motional modes of the ion chain, wherein the plurality of trapped ions comprises a plurality of first trapped ions that are addressable by laser beams, and a plurality of second trapped ions that are not addressable by laser beams,
the second operations comprise:
computing a first map of the plurality of first trapped ions to the plurality of motional modes, wherein the plurality of motional mode comprises a plurality of first motional modes that are allocated by the first map and a plurality of second motional modes that are unallocated by the first map,
the first operations further comprise:
measuring frequencies of the plurality of first motional modes, by measuring motional sideband transitions in the plurality of first trapped ions,
the second operations further comprise:
computing a second map of the plurality of first trapped ions to the plurality of second motional modes,
the first operations further comprise:
measuring frequencies of the plurality of second motional modes, by measuring motional sideband transitions in the first trapped ions that are mapped to the plurality of second motional modes, and
the second operations further comprise:
outputting, by the classical computer, the measured frequencies of the plurality of motional modes, to be used for computing a pulse to be applied to the ion chain for performing an entangling gate operation between a pair of trapped ions in the ion chain.

14. The quantum computing system according to claim 13, wherein
each of the trapped ions is an ion having a nuclear spin and an electron spin such that a difference between the nuclear spin and the electron spin is zero.

15. The quantum computing system according to claim 14, wherein
each of the trapped ions is an ion having a nuclear spin ½ and the ²S_{1/2} hyperfine states.

16. The quantum computing system according to claim 13, wherein the first map is computed based on a maximum weight matching method.

17. The quantum computing system according to claim 13, wherein the second map is computed based on a maximum weight matching method.

18. The quantum computing system according to claim 13, wherein
the second operations further comprise:
computing a third map of the first trapped ions that are not mapped to the plurality of second motional modes to the plurality of motional modes that are not allocated by the second map, wherein the plurality of motional modes that are not allocated by the second map comprises a plurality of third motional modes that are allocated by the third map and a plurality of fourth motional modes that are not allocated by the third map, and
the first operations further comprise:
measuring, by the system controller, frequencies of the plurality of third motional modes, by measuring motional sideband transitions in the first trapped ions that are mapped to the plurality of third motional modes.

19. The quantum computing system according to claim 13, wherein
the second operations further comprise:
computing an amplitude function and a detuning frequency function of a pulse to be applied to the ion chain for performing an entangling gate operation between a pair of trapped ions in the ion chain, based on the outputted frequencies of the frequencies of the plurality of motional modes of the ion chain, and
the first operations further comprise:
applying, by the system controller, the pulse having the computed amplitude function and the detuning frequency function to the ion chain to perform the entangling gate operation between the pair of trapped ions in the ion chain.

20. The quantum computing system according to claim 13 wherein the measuring of motional sideband transitions in the plurality of first trapped ions is performed by using laser beams that are focused on individual trapped ions at individually controlled laser beam frequencies.
